(19) United States
(12) Patent Application Publication
(10) Pub. No.: US 2011/0093432 A1
(43) Pub. Date: Apr. 21, 2011

(54) SYSTEM AND METHOD FOR WORKFLOW MANAGEMENT OF DOCUMENT PROCESSING DEVICES

(76) Inventors: William SU, Riverside, CA (US); Jianxin Wang, Trabuco Canyon, CA (US); Hongfeng Wei, Cerritos, CA (US)

(21) Appl. No.: 12/817,729

(22) Filed: Jun. 17, 2010

Related U.S. Application Data
(60) Provisional application No. 61/253,114, filed on Oct. 20, 2009.

(51) Int. Cl. G06F 17/30

(52) U.S. Cl. 707/608; 707/E17.008

(57) ABSTRACT

The subject application is directed to a document processing workflow system and method. On an associated display, a web output is generated and a document processing instructions is received for commencing an operation on a document processing device. A workflow manager commences a workflow instance based upon the received document processing instruction. The workflow instance includes ascertaining the status of the operation, generating an error signal based upon the status, and generating an image on the display that corresponds to the output of the document processing device resulting from the operation. The workflow instance also includes the receipt of a location specified by the user for a data storage that is associated with the operation, and exchanging electronic document data with the user-specified data storage location.

### CROSS-REFERENCE TO RELATED APPLICATIONS

This application claims priority to U.S. Provisional Patent Application Ser. No. 61/253,114, filed on Oct. 20, 2009 titled “SYSTEM AND METHOD TO MANAGE THE WORKFLOW OF MFP WEB PAGES AND WEB PARTS VIA A JOB MANAGER COMPONENT”, the entirety of which is incorporated herein.

### BACKGROUND OF THE INVENTION

The subject application is directed generally to operational workflow of data processing devices. The application is particularly applicable to effective workflow management in connection with web-based device interfaces.

Document processing devices in widespread use today include copiers, printers, e-mail gateways, facsimile machines, and scanners. Modern devices frequently include two or more of these devices and are referred to as multifunction peripherals (MFPs) or multifunction devices (MFDs). The complexity of these devices is frequently managed by interaction with an integrated computer system, referred to as a controller. MFP devices are frequently placed in data communication with other devices via a network connection. Such networked devices may include other document processing devices, workstations, servers, or document management systems.

More recently, interaction with document processing devices is via a thin client interface, such as a web client. Such web-based interaction allows for either control of a document processing device or use of the devices interface to exchange document data with one or more networked devices.

### SUMMARY OF THE INVENTION

In accordance with one embodiment of the subject application, there is provided a document processing workflow system and method. A web output is first generated on an associated display. Thereafter, a document processing instruction is received to commence a document processing operation on an associated document processing device. On a processor, which is programmed as a workflow manager, a workflow instance, based upon the received document processing instruction, is commenced. The workflow instance includes the ascertaining of the status of the document processing operation, the generation of an error signal based upon the status, and the generation of an image on the display that corresponds to an output of the document processing device resulting from the document processing operation. The workflow instance further includes the receipt of a location specified by the user for a data storage that is associated with the document processing operation, and exchanging electronic document data with the user-specified data storage location.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for document processing workflow according to one embodiment of the subject application;

FIG. 2 is a block diagram illustrating device hardware for use in the system for document processing workflow according to one embodiment of the subject application;

FIG. 3 is a functional diagram illustrating the device for use in the system for document processing workflow according to one embodiment of the subject application;

FIG. 4 is a block diagram illustrating controller hardware for use in the system for document processing workflow according to one embodiment of the subject application;

FIG. 5 is a functional diagram illustrating the controller for use in the system for document processing workflow according to one embodiment of the subject application;

FIG. 6 is a functional diagram illustrating a workstation for use in the system for document processing workflow according to one embodiment of the subject application;

FIG. 7 is a functional diagram illustrating a server for use in the system for document processing workflow according to one embodiment of the subject application;

FIG. 8 is a block diagram illustrating the system for document processing workflow according to one embodiment of the subject application;

FIG. 9 is a functional diagram illustrating the system for document processing workflow according to one embodiment of the subject application;

FIG. 10 is a flowchart illustrating a method for document processing workflow according to one embodiment of the subject application;

FIG. 11 is a flowchart illustrating a method for document processing workflow according to one embodiment of the subject application;

FIG. 12 is a flowchart illustrating a scan to repository (storage) workflow operation implemented in accordance with one embodiment of the subject application; and

FIG. 13 is a flowchart illustrating an example of a scan to email workflow operation implemented in accordance with one embodiment of the subject application.

### DETAILED DESCRIPTION OF THE PREFERRED EMBODIMENT

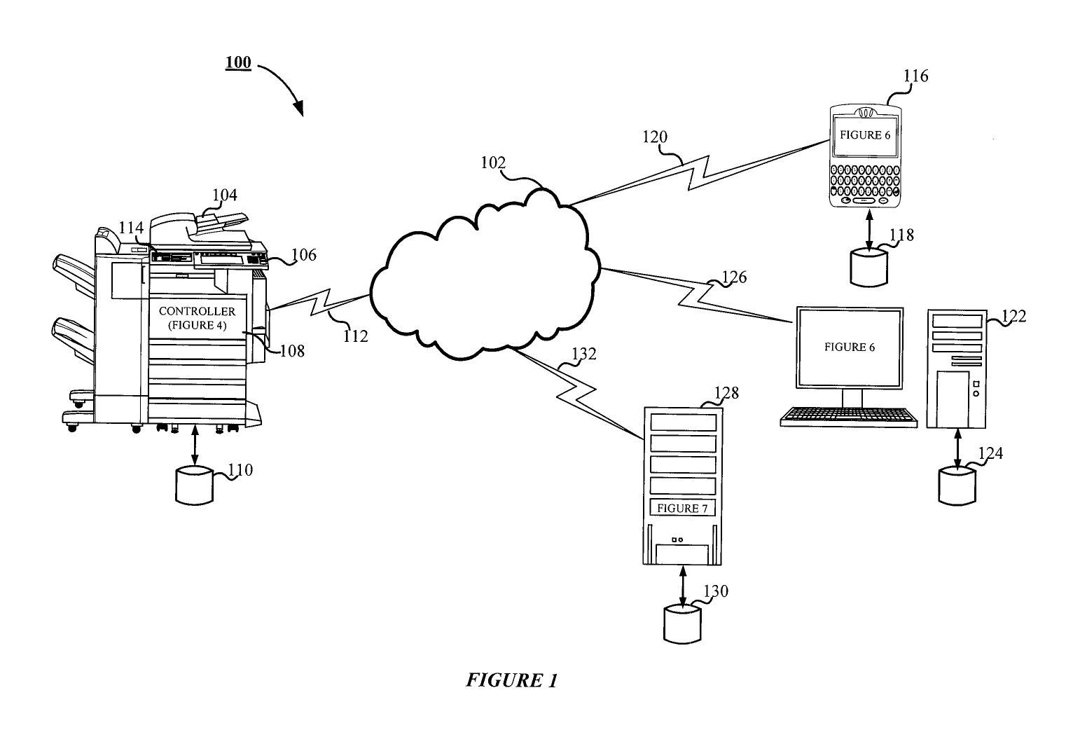

The subject application is directed to a system and method for operational workflows of data processing devices. In particular, the subject application is directed to a system and method for effective workflow management in connection with web-based device interfaces. More particularly, the subject application is directed to a document processing operation workflow system and method. It will become apparent to those skilled in the art that the system and method described herein are suitably adapted to a plurality of varying electronic fields employing web-based device interfaces, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of an example system 100 for document processing workflow in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

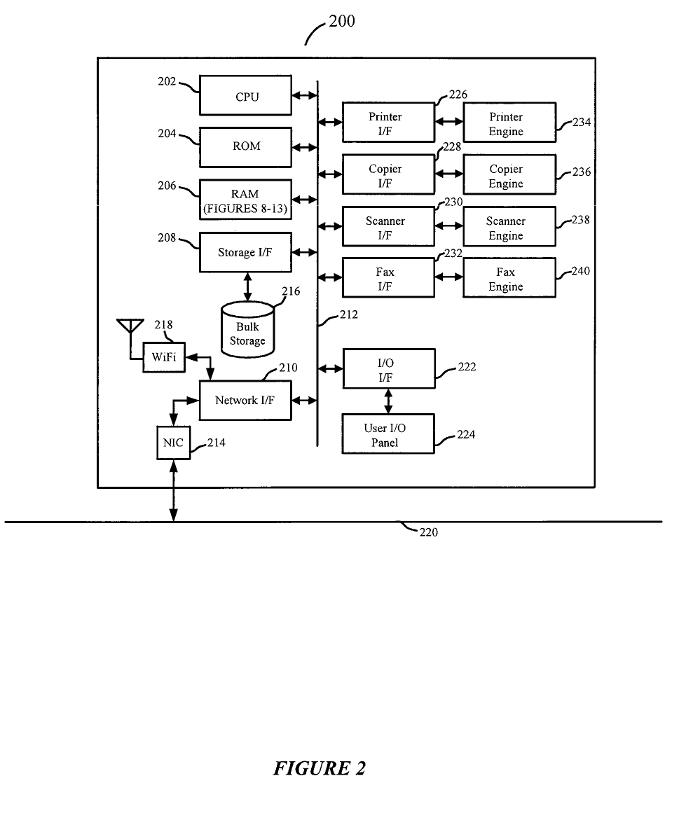

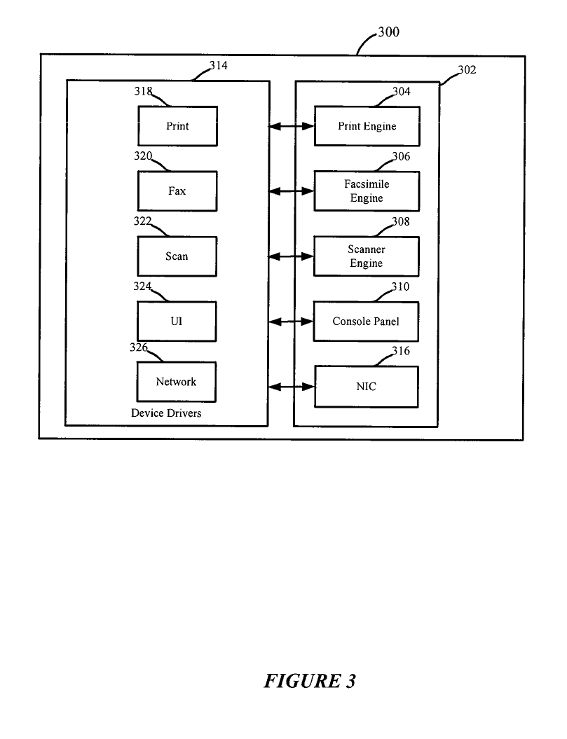

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

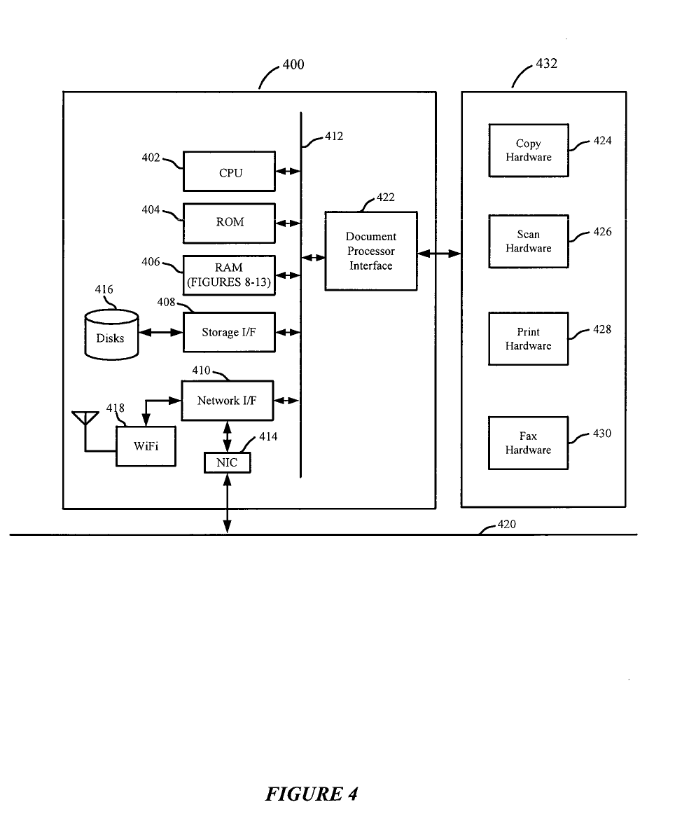

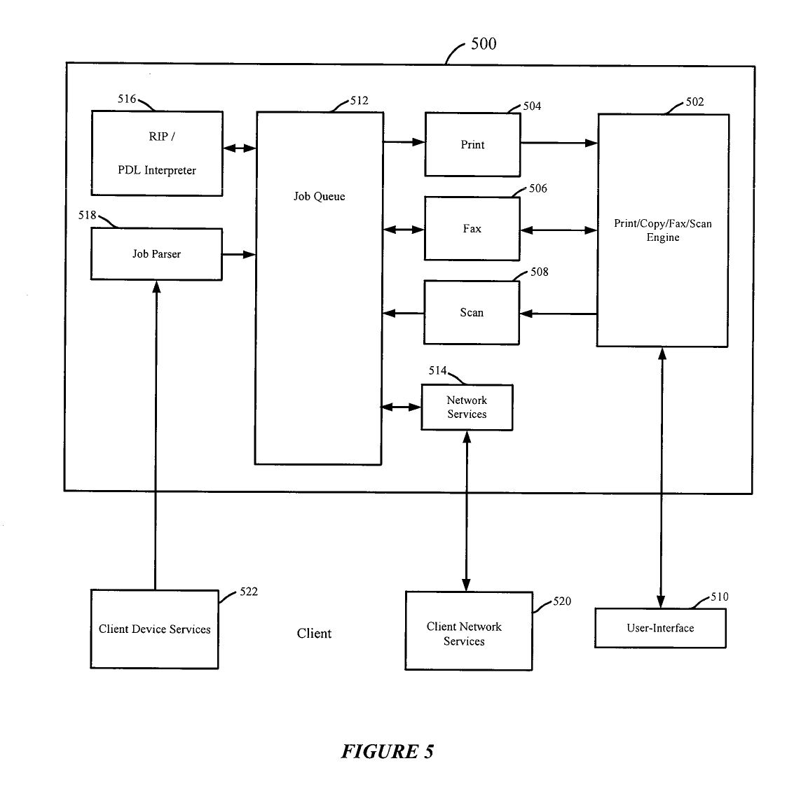

In accordance with one embodiment of the subject application, the document processing device 104 incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for document processing workflow. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, modified image data, redacted data, user information, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like. The document processing device of FIG. 1 also includes a portable storage device reader 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

Also depicted in FIG. 1 is a plurality of user devices, illustrated as a portable telecommunication device 116 and a networked data processing device, illustrated as the computer workstation 122. The portable telecommunication device 116 is preferably in data communication with the computer network 102 via the communication link 120, while the computer workstation 122 is similarly in data communication with the computer network 102 via the communication link 126. It will be appreciated by those skilled in the art that the portable telecommunication device 116 and the computer workstation 122 are shown respectively in FIG. 1 as a portable proprietary data device and a personal computer for illustration purposes only. As will be understood by those skilled in the art, the portable telecommunication device 116 and the computer workstation 122 are representative of any personal computing device known in the art including, for example and without limitation, a laptop computer, a personal computer, a personal data assistant, a web-enabled cellular telephone, a smart phone, a proprietary network device, or other web-enabled electronic device capable of network communications. According to one embodiment of the subject application, the user devices 116 and 122 include software, hardware, or a suitable combination thereof configured to interact with the document processing device 104, the server 128, or the like.

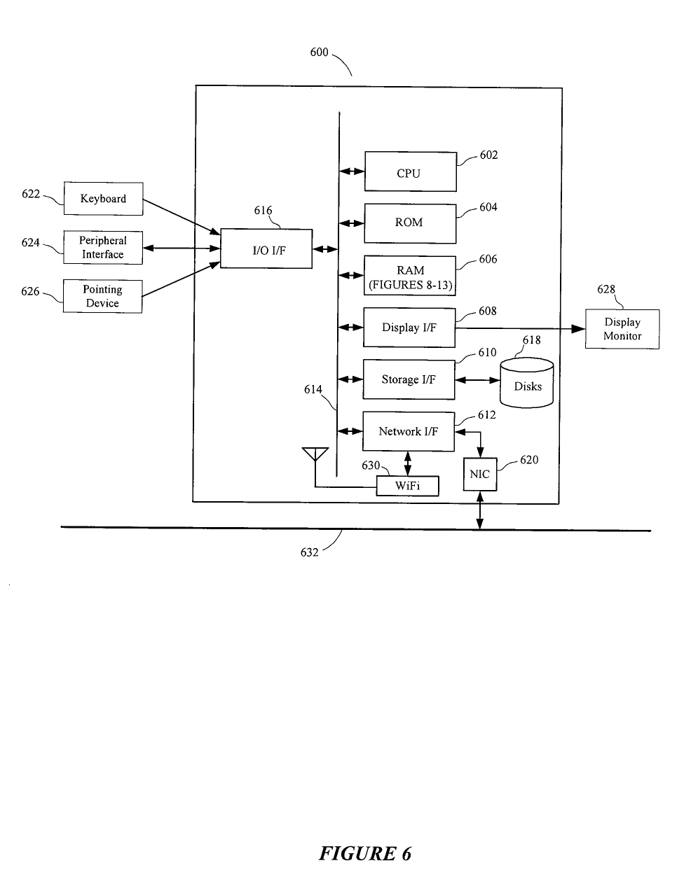

The communication links 120 and 126 are any suitable channel of data communications known in the art including, but not limited to wireless communications, for example and without limitation, BLUETOOTH, WiMax, 802.11a, 802.11b, 802.11g, 802.11(x), a proprietary communications channel, infrared, optical, the public switched telephone network, or any suitable wireless data transmission system, or wired communications known in the art. Preferably, the user devices 116 and 122 are suitably adapted to provide or receive contact information, address book data, document data, job data, user interface data, image data, monitor document processing jobs, employ thin-client interfaces, generate display data, generate output data, or the like, with respect to the document processing device 104, or any other similar device coupled to the computer network 102. According to one embodiment of the subject application, the user devices 116 and 122 are capable of implementing various graphical user interface applications for interacting with a user, as will be appreciated by those skilled in the art to include a physical keyboard, a soft keyboard via an associated touch screen interface, or a suitable combination thereof. The functioning of the user devices 116 and 122 will better be understood in conjunction with the block diagram illustrated in FIG. 6, explained in greater detail below.

Communicatively coupled to the portable telecommunication device 116 is a data storage device 118, while a data storage 124 is similarly in data communication with the computer workstation 122. According to one embodiment of the subject application, the data storage devices 118 and 124 are any mass storage device, or plurality of such devices, known in the art including, for example and without limitation, magnetic storage drives, a hard disk drive, optical storage devices, flash memory devices, or any suitable combination thereof. In such an embodiment, the data storage device 124 is suitably adapted to store operating systems, address book data, personal information, account information, identification data, regional data, thin client interface data, keyboard layout data, keyboard property data, HTML keyboard data, JavaScript keyboard data, update software, policy information, and the like. It will be appreciated by those skilled in the art that while illustrated in FIG. 1 as being a separate component of the system 100, the data storage device 124 is capable of being implemented as an internal storage component of the computer workstation 122.

The system 100 illustrated in FIG. 1 further depicts a backend component, shown as the server 128, in data communication with the computer network 102 via a communications link 132. It will be appreciated by those skilled in the art that the server 128 is shown in FIG. 1 as a component of the system 100 for example purposes only, and the subject application is capable of implementation without the use of a separate backend server component. The skilled artisan will appreciate that the server 128 comprises hardware, software, and combinations thereof suitably adapted to provide one or more services, web-based applications, storage options, and the like, to networked devices. In accordance with one example embodiment of the subject application, the server 128 includes various components, implemented as hardware, software, or a combination thereof, for managing retention of secured documents, text data, performing searches, comparisons, maintaining database entries, account information, receiving payment data, retrieval of documents, and the like, which are accessed via the computer network 102. Suitable examples of such a server 128 include, for example and without limitation, a Microsoft® SharePoint® server, a Microsoft® Exchange® server, a Research in Motion® Blackberry Enterprise® server, or other commonly referenced ‘servers’, as will be understood by those skilled in the art.

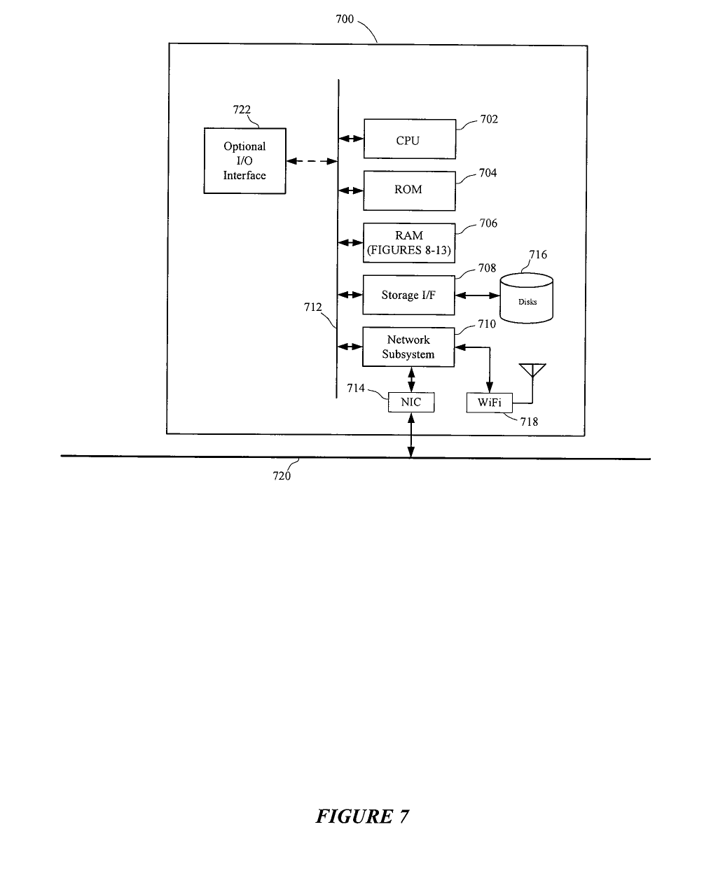

The communications link 132 is any suitable data communications means known in the art including, but not limited to wireless communications comprising, for example and without limitation BLUETOOTH, WiMax, 802.11a, 802.11b, 802.11g, 802.11(x), a proprietary communications network, infrared, the public switched telephone network, optical, or any suitable wireless data transmission system, or wired communications known in the art. It will further be appreciated by those skilled in the art that the components described with respect to the server 128 are capable of implementation on any suitable computing device coupled to the computer network 102, e.g. the controller 108, the portable telecommunication device 116, the computer workstation 122, or the like. The functioning of the server 128 will better be understood in conjunction with the block diagram illustrated in FIG. 7, explained in greater detail below.

Communicatively coupled to the server 128 is the data storage device 130. According to the foregoing example embodiment, the data storage device 130 is any mass storage device, or plurality of such devices, known in the art including, for example and without limitation, magnetic storage drives, a hard disk drive, optical storage devices, flash memory devices, or any suitable combination thereof. In such an embodiment, the data storage device 130 is suitably adapted to store mapping data, document rendering device location data, database entries, software updates, secured electronic documents, text data, data strings, account information, policy information, and the like. It will be appreciated by those skilled in the art that while illustrated in FIG. 1 as being a separate component of the system 100, the data storage device 130 is capable of being implemented as an internal storage component of the server 128, or the like, such as, for example and without limitation, an internal hard disk drive, or the like.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document rendering devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document rendering device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document processing device 104, which includes the controller 400 of FIG. 4, (shown in FIG. 1 as the controller 108) as an intelligent subsystem associated with a document rendering device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the portable telecommunication device 116 or the workstation 122, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

Turning now to FIG. 7, illustrated is a representative architecture of a suitable server 700 (depicted in FIG. 1 as the server 128), on which operations of the subject system are completed. Included is a processor 702, suitably comprised of a central processor unit. However, it will be appreciated that processor 702 may advantageously be composed of multiple processors working in concert with one another as will be appreciated by one of ordinary skill in the art. Also included is a non-volatile or read only memory 704 which is advantageously used for static or fixed data or instructions, such as BIOS functions, system functions, system configuration, and other routines or data used for operation of the server 700.

Also included in the server 700 is random access memory 706, suitably formed of dynamic random access memory, static random access memory, or any other suitable, addressable memory system. Random access memory provides a storage area for data instructions associated with applications and data handling accomplished by the processor 702.

A storage interface 708 suitably provides a mechanism for volatile, bulk or long term storage of data associated with the server 700. The storage interface 708 suitably uses bulk storage, such as any suitable addressable or serial storage, such as a disk, optical, tape drive and the like as shown as 716, as well as any suitable storage medium as will be appreciated by one of ordinary skill in the art.

A network interface subsystem 710 suitably routes input and output from an associated network allowing the server 700 to communicate to other devices. The network interface subsystem 710 suitably interfaces with one or more connections with external devices to the server 700. By way of example, illustrated is at least one network interface card 714 for data communication with fixed or wired networks, such as Ethernet, token ring, and the like, and a wireless interface 718, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 714 is interconnected for data interchange via a physical network 720, suitably comprised of a local area network, wide area network, or a combination thereof.

Data communication between the processor 702, read only memory 704, random access memory 706, storage interface 708 and the network subsystem 710 is suitably accomplished via a bus data transfer mechanism, such as illustrated by bus 712.

Suitable executable instructions on the server 700 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 722 as will be appreciated by one of ordinary skill in the art.

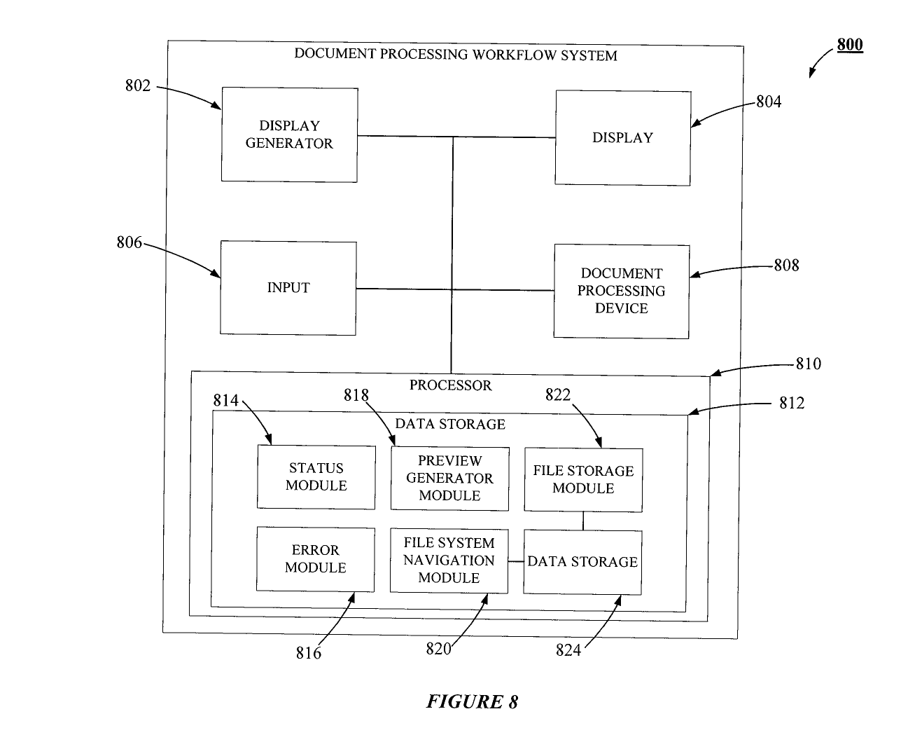

Referring now to FIG. 8, illustrated is a block diagram of a system 800 for document processing workflow in accordance with one embodiment of the subject application. The document processing workflow system 800 includes a display generator 802 that is configured to generate a web output on an associated display 804. The system 800 further includes an input 806 that is configured to receive a document processing instruction to commence a document processing operation on an associated document processing device 808. In addition, the system 800 incorporates a processor 810 that is programmed as a workflow manager. This workflow manager is suitably configured to commence a workflow instance 812 based upon the received document processing instruction. The workflow instance 812 a status module 814, an error module 816, a preview generator module 818, a file system navigation module 820, and a file storage module 822.

The status module 814 is configured to check a status of the document processing operation, while the error module 816 is operable to generate an error signal based upon output of the status module 814. The preview generator module 818 is suitably configured to generate an image on the display 804 that corresponds to the output of the document processing device 808 resulting from the document processing operation. According to one embodiment of the subject application, the file system navigation module 820 is configured to allow for a user-specified location for a data storage 824 that is associated with the document processing operation, and the file storage module 822 is operable to exchange electronic document data with the storage location 824 in accordance with the output of the file system navigation module 820

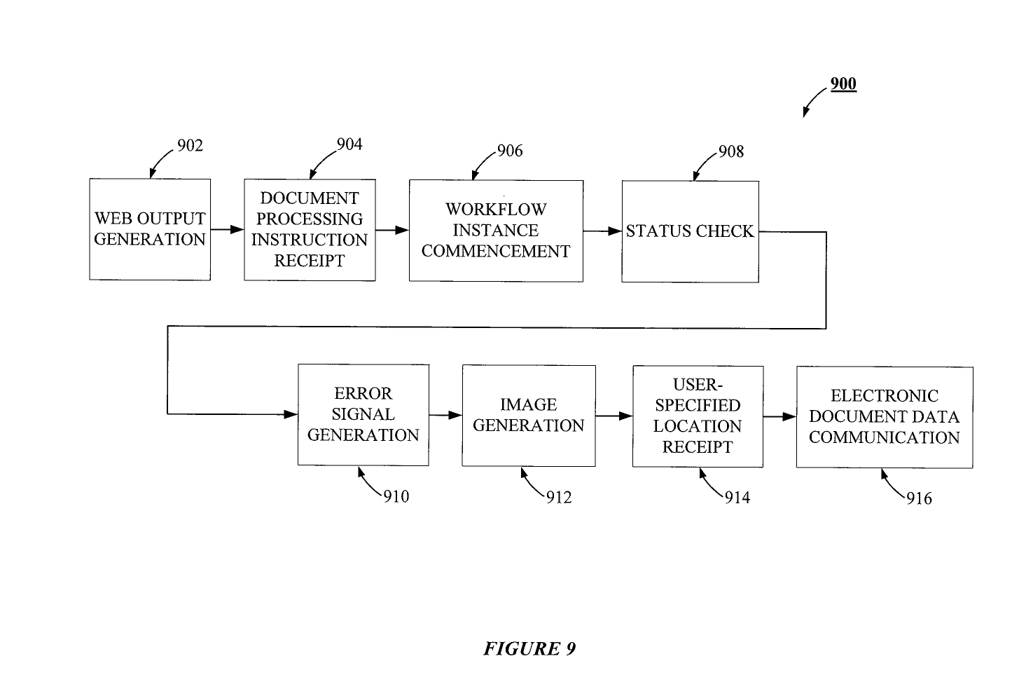

Turning now to FIG. 9, illustrated is a functional diagram of a system 900 for document processing workflow in accordance with one embodiment of the subject application. As shown in FIG. 9, web output generation 902 is first performed on an associated display. Document processing instruction receipt 904 then occurs of an instruction to commence a document processing operation on an associated document processing device. Next, workflow instance commencement 906 is initiated on a processor that is programmed as a workflow manager based upon the received document processing instruction.

A status check 908 is then performed on the status of the document processing operation. Thereafter, error signal generation 910 occurs of an error based upon the status. Image generation 912 is then performed of an image on the display corresponding to an output of the document processing device resulting from the document processing operation. User-specified location receipt 914 of a location that corresponds to a data storage associated with the document processing operation then occurs. Next, electronic document data exchange 916 of document data with the user-specified data storage location is performed.

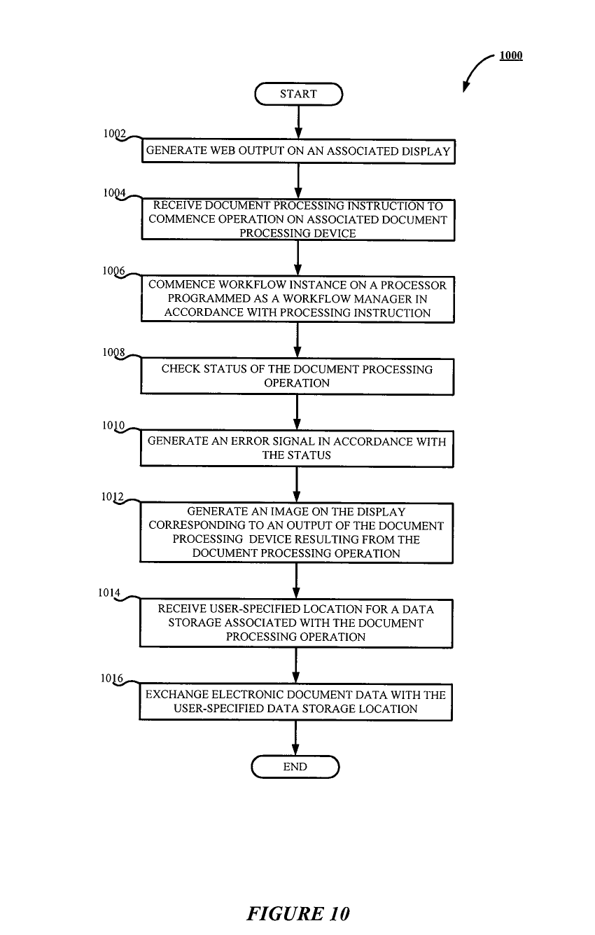

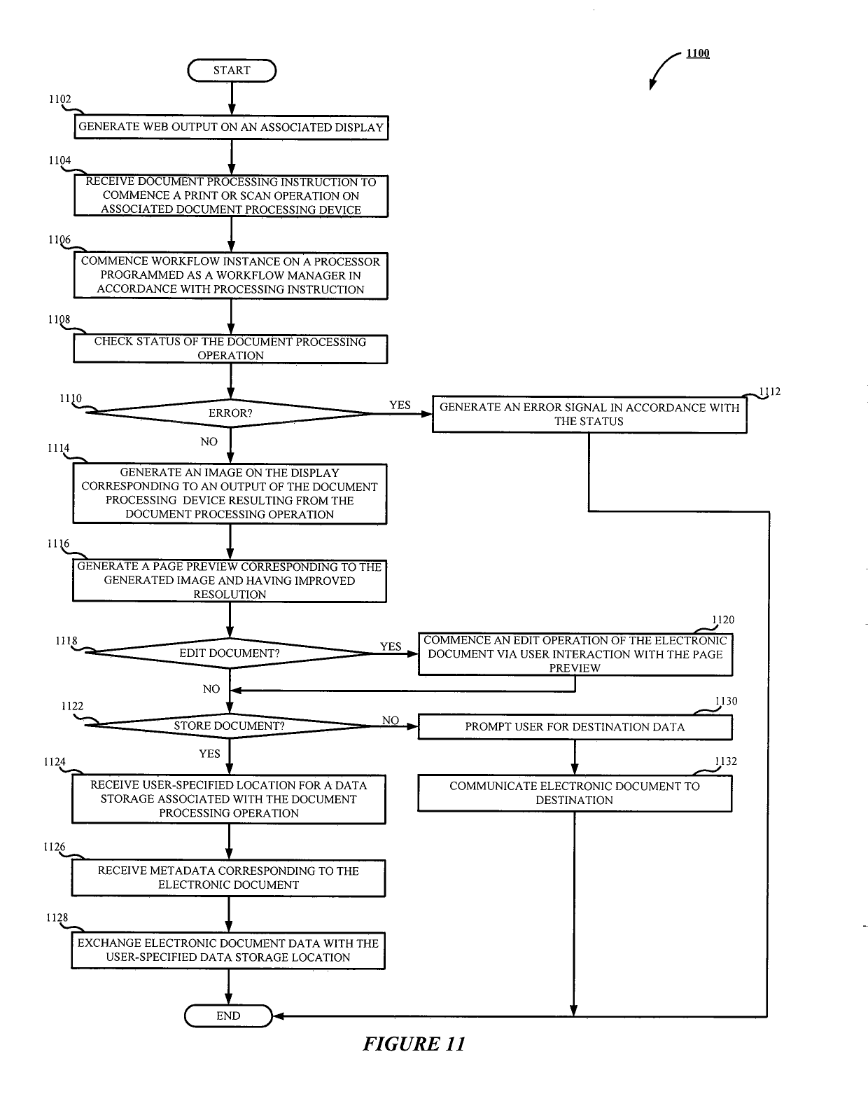

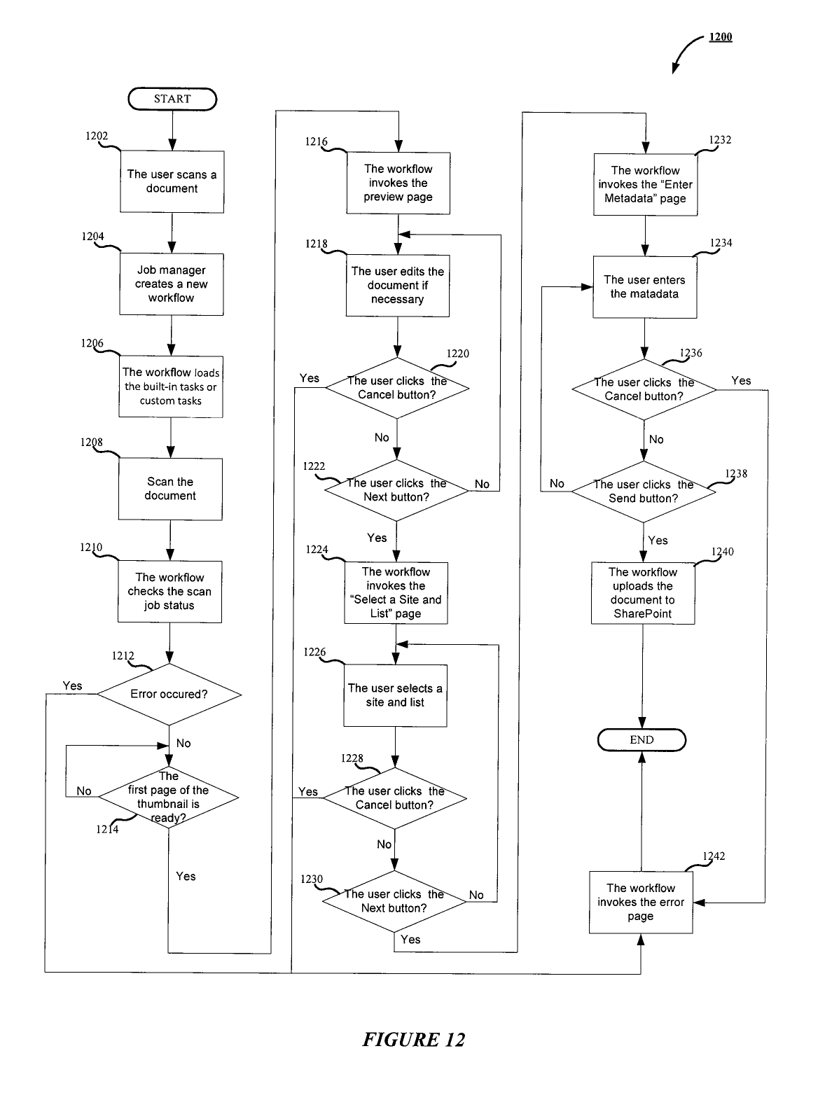

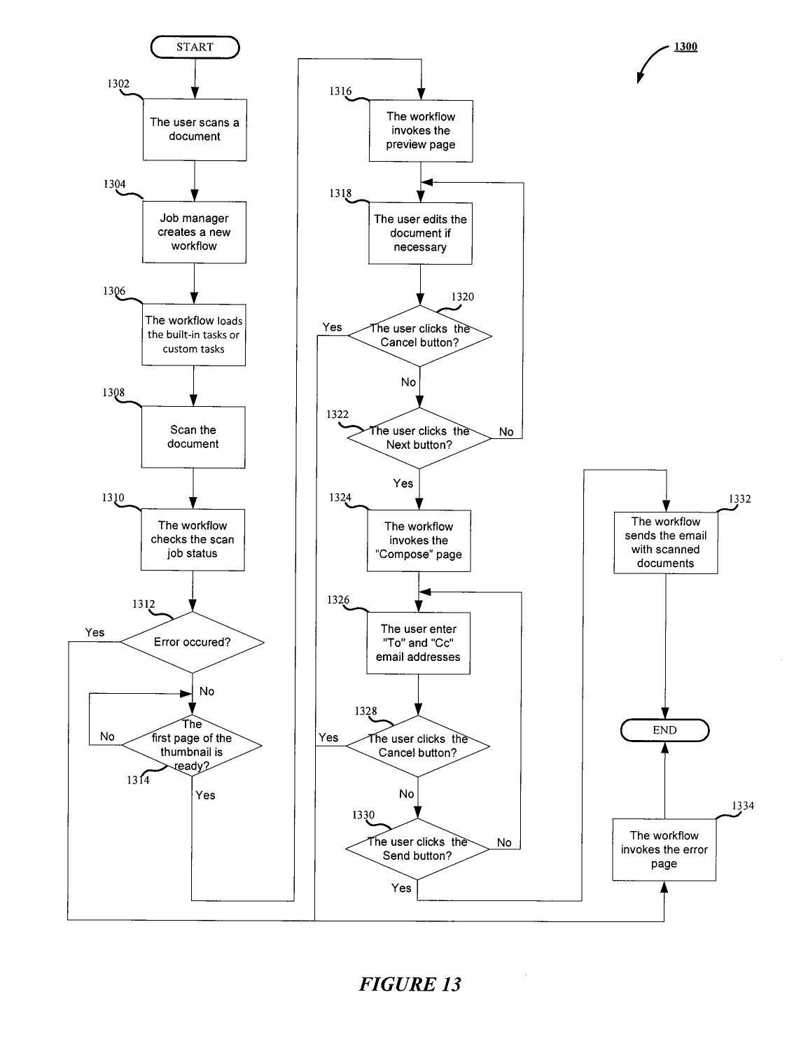

The skilled artisan will appreciate that the subject system 100 and components described above with respect to FIG. 1, FIG. 2, FIG. 3, FIG. 4, FIG. 5, FIG. 6, FIG. 7, FIG. 8, and FIG. 9 will be better understood in conjunction with the methodologies described hereinafter with respect to FIG. 10 and FIG. 11, as well as the example illustrations of the embodiments depicted in FIG. 12 and FIG. 13. Turning now to FIG. 10, there is shown a flowchart 1000 illustrating a method for document processing workflow in accordance with one embodiment of the subject application. Beginning at step 1002, a web output is generated on an associated display. At step 1004, a document processing instruction is received. Preferably, the document processing instruction directs the commencement of a document processing operation on an associated document processing device. At step 1006, a workflow instance is commenced on a processor that is programmed as a workflow manager based upon the received document processing instruction.

At step 1008, the status of the document processing operation is checked. An error signal is then generated at step 1010 in accordance with the status checked at step 1008. At step 1012, an image is generated on the display corresponding to an output of the document processing device resulting from the document processing operation. A user-specified location for a data storage associated with the document processing operation is then received at step 1014. At step 1016, electronic document data is exchanged with the data storage location specified by the user at step 1014.

Referring now to FIG. 11, there is depicted a flowchart 1100 illustrating a method for document processing workflow in accordance with one example embodiment of the subject application. The methodology of FIG. 11 begins at step 1102, whereupon a web output is generated on an associated display, e.g. the user interface 106 associated with the document processing device 104, the display associated with the user devices 116, 122, or the like. It will be appreciated by those skilled in the art that such a display is capable of including, for example and without limitation, a thin client interface displayable on an associated web browser, or the like. At step 1104, a document processing instruction is received from an associated user corresponding to an instruction to commence either a scanning operation or a printing operation by the document processing device 104. The skilled artisan will appreciate that the use of a scanning or printing operation is used for example purposes only, and other document processing operations, e.g. copying, facsimile transmission, scan to a location, electronic mail, and the like, are equally capable of being undertaken in accordance with the methodology of FIG. 11.

Following receipt of the instructions from the associated user, e.g. via the user interface 106 or remotely via the user devices 116, 122, flow proceeds to step 1106, whereupon a workflow instance is commenced on a processor, e.g. a processor associated with the controller 108, that is capable of functioning as a workflow manager in accordance with the scan or print processing instruction. The skilled artisan will appreciate that the reference herein to the controller 108 is intended as an example for FIG. 11, and the methodology is capable of implementation via a suitable processor associated with the user devices 116, 122, or other such electronic device.

The status associated with the document processing operation is then checked at step 1108 so as to determine, at step 1110, whether an error has occurred. In the event an error has been detected, flow proceeds to step 1112, whereupon an error signal is generated based upon the detected status of the processing operation. In accordance with one embodiment of the subject application, the generation of an error signal includes the display, via the user interface 106, the user devices 116, 122, or the like, indicative of the error, such as, for example and without limitation, an error page, an audible signal, a message (SMS, email, text), or other notification/alert mechanism.

When no error is detected at step 1110, operations progress to step 1114, whereupon an image is generated on the display corresponding to the results of the document processing operation performed by the document processing device 104. The skilled artisan will appreciate that such a display includes, for example and without limitation, the user interface 106, the user devices 116, 122, or other suitable electronic computing device in communication with the document processing device 104 or network 102. At step 1116, a page preview of an output of the generated image is then generated on the display (user interface 106, user devices 116, 122, etc.) representing a higher resolution image of the results of the operation, e.g. a higher resolution display of a scanned document.

A determination is then made at step 1118 whether the associated user has selected to edit the electronic document generated as a result of the document processing operation performed by the document processing device 104. The skilled artisan will appreciate that selection of such editing is capable of being received by the controller 108 via the user interface 106, communications from the user devices 116, 122, or the like. Upon a determination at step 1118 that the user has selected to edit the document, operations proceed to step 1120, whereupon an edit operation is commenced on the electronic document via the user interaction with the page preview.

When it is determined at step 1118 that editing is not desired, or after completion of the editing operation of step 1120, flow proceeds to step 1122. At step 1122, a determination is made whether the user has selected to store the electronic document resulting from the document processing operation. Upon a positive determination, flow proceeds to step 1124, whereupon a user-specified location for a data storage associated with the operation is received. According to one embodiment of the subject application, the storage corresponds to the server 128, a portable storage location, a network location, or the like. Metadata is then received at step 1126 corresponding to the electronic document, e.g. from the user, generated via the controller 108, communicated via the user devices 116, 122, the server 128, or the like. The electronic document data is then exchanged with the user-specified location for storage with the associated metadata at step 1128, whereupon operations with respect to FIG. 11 terminate.

Returning to step 1122, when it is determined that storage is not selected, flow proceeds to step 1130, whereupon the user is prompted via the user interface 106, the user device 116, 122, or the like, for a destination for the electronic document. It will be appreciated by those skilled in the art that such destination includes, for example and without limitation, a facsimile destination (number), an electronic mail destination (email address), a print destination (print command), and the like. The electronic document is then communicated to the destination as selected by the user at step 1132, whereupon operations with respect to FIG. 11 terminate.

Referring now to FIG. 12, there is depicted a flowchart 1200 illustrating an example of a scan to repository (storage) workflow operation implemented in accordance with one embodiment of the subject application. The methodology of FIG. 12 begins at step 1202, whereupon an associated user scans a document via the document processing device 104. At step 1204, a job manager, resident on the controller 108 associated with the document processing device 104, creates a new workflow as will be appreciated by those skilled in the art. The controller 108 then loads, via the workflow, built-in tasks or custom tasks as required at step 1206. The document processing device then performs a scanning operation at step 1208.

In accordance with the created workflow, the scan job status is then checked at step 1210 and a determination is made at step 1212 whether an error has occurred. In the event that an error is detected, flow proceeds to step 1242, whereupon the workflow directs the invocation of an error page to be displayed to the user and operations with respect to FIG. 12 terminate. Upon a determination at step 1212 that no error has occurred, flow progresses to step 1214, whereupon a determination is made whether the first page of the thumbnail is ready for viewing. If the thumbnail of the first page is not ready, operations return to step 1212 until such time as the thumbnail is ready. Once ready, flow proceeds from step 1214 to step 1216, whereupon the preview page is invoked by the workflow.

At step 1218, the user is provided with the ability to edit the document, if desired. A determination is then made at step 1220 whether the user has selected a ‘cancel’ icon suitably displayed on the user interface. Upon a positive determination at step 1220, operations proceed to step 1242, whereupon the error page is invoked and displayed to the user, following which methodology of FIG. 12 terminates. Returning to step 1220, upon a determination that the user has not selected the cancel button, or icon, flow proceeds to step 1222, wherein a determination is made whether the user has selected a ‘next’ icon, i.e. an input indicating a user's intention to progress with the document processing operation. In the event that the user does not select the ‘next’ icon or button, displayed via the user interface, flow proceeds to step 1232, whereupon the job manager associated with the controller 108 or other suitable component of the document processing device 104 invokes an ‘enter metadata’ page, i.e. a display prompt for the user to input metadata associated with the scan job.

The user then inputs the metadata at step 1234, and unless the user selects a ‘cancel’ icon at step 1236, operations progress to step 1238. At step 1238, a determination is made whether the user has selected a ‘send’ icon, indicative of a request by the user to communicate the scan job to the selected destination, e.g. a Microsoft® SharePoint® server, such as the server 128 depicted in FIG. 1, or the like. The skilled artisan will appreciate that reference is made herein to the server 128 as a SharePoint® server by Microsoft® for example purposes only, and the methodology of FIG. 12 is representative of such an example implementation of the subject application. A negative determination at step 1238 returns operations to metadata entry at step 1234, while a positive determination at step 1238 prompts the workflow to upload the document of the scan job to the SharePoint® server 128 at step 1240, whereupon operations with respect to FIG. 12 terminate.

Returning to step 1222, upon a determination that the user has selected the appropriate ‘next’ icon or button displayed via the associated user interface, e.g. the user interface 106 or the user devices 116 and 122, flow proceeds to step 1224. At step 1224, the job manager, via the workflow, invokes a ‘Select a Site and List’ page. It will be appreciated by those skilled in the art that this selection page enables the user to select the desired upload location of the resultant scanned document. Thus, at step 1226, the user selects the desired location and list to which the scan job is destined. A determination is then made at step 1228 whether the user has selected a ‘cancel’ icon or button so as to cancel the document processing operation associated with the workflow. A positive determination at step 1228 results in the workflow error page invocation of step 1242 as discussed above. A negative determination at step 1228 results in a determination at step 1230 whether the user has selected a ‘next’ button or icon, i.e. indicating a desire to proceed with the workflow generation of the scanning operation. A negative determination at step 1230 returns operations to step 1226 for user selection as discussed above. Once a positive determination is made at step 1230, flow proceeds to step 1232 for invocation of the ‘Enter Metadata’ page (user interface display) as previously discussed. Operations with respect to FIG. 12 thereafter continue as set forth above until the workflow uploads the document to the SharePoint® server 128 at step 1240.

Turning now to FIG. 13, there is shown a flowchart 1300 illustrating an example of a scan to electronic mail (email) workflow operation implemented in accordance with one embodiment of the subject application. The methodology of FIG. 13 begins at step 1302, whereupon an associated user scans a document via the document processing device 104. At step 1304, a job manager, resident on the controller 108 associated with the document processing device 104, creates a new workflow as will be appreciated by those skilled in the art. The controller 108 then loads, via the workflow, built-in tasks or custom tasks as required at step 1306, e.g. custom tasks focused on a particular vendor's product. The document processing device then performs a scanning operation at step 1308.

In accordance with the created workflow, the scan job status is then checked at step 1310 and a determination is made at step 1312 whether an error has occurred. In the event that an error is detected, flow proceeds to step 1334, whereupon the workflow directs the invocation of an error page to be displayed to the user and operations with respect to FIG. 13 terminate. Upon a determination at step 1312 that no error has occurred, flow progresses to step 1314, whereupon a determination is made whether the first page of the thumbnail is ready for viewing. If the thumbnail of the first page is not ready, operations return to step 1312 until such time as the thumbnail is ready. Once ready, flow proceeds from step 1314 to step 1316, whereupon the preview page is invoked by the workflow.

At step 1318, the user is provided with the ability to edit the document, if desired. A determination is then made at step 1320 whether the user has selected a ‘cancel’ icon suitably displayed on the user interface. Upon a positive determination at step 1320, operations proceed to step 1334, whereupon the error page is invoked and displayed to the user, following which methodology of FIG. 13 terminates. Returning to step 1320, upon a determination that the user has not selected the cancel button, or icon, flow proceeds to step 1322, wherein a determination is made whether the user has selected a ‘next’ icon, i.e. an input indicating a user's intention to progress with the document processing operation. In the event that the user does not select the ‘next’ icon or button, displayed via the user interface, flow returns to step 1318, whereupon the user is prompted to edit the document, if desired.

When it is determined at step 1322 that the user has selected the appropriate ‘next’ icon or button displayed via the associated user interface, e.g. the user interface 106 or the user devices 116 and 122, flow proceeds to step 1324. At step 1324, the job manager, via the workflow, invokes a ‘compose’ page on the user interface, whereupon the user is prompted, at step 1326 to input the desired recipients, including any copies. At step 1328, a determination is made whether the user has selected a ‘cancel’ icon or button so as to cancel the scan to electronic mail operation associated with the workflow. A positive determination at step 1328 results in the workflow error page invocation of step 1334 as discussed above. A negative determination at step 1328 results in a determination at step 1330 whether the user has selected a ‘next’ button or icon, i.e. indicating a desire to proceed with the workflow generation of the scan to electronic mail operation. A negative determination at step 1330 returns operations to step 1326 for user selection as discussed above. Once a positive determination is made at step 1330, flow proceeds to step 1332, whereupon the workflow directs the communication of the scan-to-email message to the designated recipients via a suitable mail server, e.g. a Microsoft® Exchange® server, such as the server 128 of FIG. 1. Operations with respect to FIG. 13 thereafter terminate.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A document processing workflow system comprising:
a display generator operable to generate a web output on an associated display;
an input operable to receive a document processing instruction to commence a document processing operation on an associated document processing device; and
a processor programmed as a workflow manager, the workflow manager operable to commence a workflow instance in accordance with the received document processing instruction, the workflow instance including,
a status module operable to check a status of the document processing operation,
an error module operable to generate an error signal in accordance with an output of the status module,
a preview generator module operable to generate an image on the display corresponding to an output of the document processing device resultant from the document processing operation,
a file system navigation module operable to allow for a user-specified location for a data storage associated with the document processing operation, and
a file storage module operable to exchange electronic document data with a storage location in accordance with an output of the file system navigation module.

2. The system of claim 1 wherein the workflow instance further includes a preview page generation module operable to generate a page preview corresponding to the generated image and having improved resolution thereto.

3. The system of claim 2 wherein the document processing instruction is an instruction corresponding to at least one of a print operation and a scan operation.

4. The system of claim 1 wherein the workflow instance further includes a metadata module operable to receive metadata corresponding to the electronic document.

5. The system of claim 4 wherein the file storage module includes a SharePoint connector.

6. The system of claim 2 wherein the workflow instance further includes an edit module operable to facilitate an edit of the electronic document via user interaction with the page preview.

7. A document processing workflow method comprising:
generating a web output on an associated display;
receiving a document processing instruction to commence a document processing operation on an associated document processing device; and
on a processor programmed as a workflow manager, commencing a workflow instance in accordance with the received document processing instruction, including,
checking a status of the document processing operation,
generating an error signal in accordance with the status,
generating an image on the display corresponding to an output of the document processing device resultant from the document processing operation,
receiving a user-specified location for a data storage associated with the document processing operation, and
exchanging electronic document data with the user-specified data storage location.

8. The method of claim 7 wherein the commencing the workflow instance further includes generating a page preview corresponding to the generated image and having improved resolution thereto.

9. The method of claim 8 wherein the document processing instruction is an instruction corresponding to at least one of a print operation and a scan operation.

10. The method of claim 7 wherein the workflow instance further includes receiving metadata corresponding to the electronic document.

11. The method of claim 8 further comprises commencing an edit operation of the electronic document via user interaction with the page preview.

12. A document processing workflow system comprising:
means adapted for generating a web output on an associated display;
means adapted for receiving a document processing instruction to commence a document processing operation on an associated document processing device; and
on a processor programmed as a workflow manager, means adapted for commencing a workflow instance in accordance with the received document processing instruction, including,
means adapted for checking a status of the document processing operation,
means adapted for generating an error signal in accordance with an output of the status module,
means adapted for generating an image on the display corresponding to an output of the document processing device resultant from the document processing operation,
means adapted for receiving a user-specified location for a data storage associated with the document processing operation, and
means adapted for exchanging electronic document data with the user-specified data storage location.

13. The system of claim 12 wherein the means adapted for commending the workflow instance further includes means adapted for generating a page preview corresponding to the generated image and having improved resolution thereto.

14. The system of claim 13 wherein the document processing instruction is an instruction corresponding to at least one of a print operation and a scan operation.

15. The system of claim 12 wherein the means adapted for commencing the workflow instance further includes means adapted for receiving metadata corresponding to the electronic document.

16. The system of claim 13 further comprising means adapted for commencing an edit operation of the electronic document via user interaction with the page preview.
